(19) United States
(12) Patent Application Publication
(10) Pub. No.: US 2018/0249008 A1
(43) Pub. Date: Aug. 30, 2018

(54) Automatic Tree System for Dialing Businesses and Associated Methods

(71) Applicant: Anand Deepak Patel, Kernersville, NC (US)

(72) Inventor: Anand Deepak Patel, Kernersville, NC (US)

(21) Appl. No.: 15/442,929

(22) Filed: Feb. 27, 2017

(51) Int. Cl. H04M 3/493; H04M 1/725; H04M 3/42; H04W 4/16

(52) U.S. Cl. CPC H04M 3/4938; H04M 1/72583; H04M 2201/38; H04M 3/4936; H04W 4/16; H04M 3/42374

(57) ABSTRACT

A computer executable program is described that allows a user to circumnavigate entities' phone trees without having to stay on the phone. The program works by allowing the user to input data into the phone tree by text driven or menu driven commands (or both). The input data then is used by the executable computer program to reach the party that the user desires to reach. The user may be notified by a visual or audible signal once the desired party is reached.

### FIELD OF THE INVENTION

The present invention relates to a computer program and/or application that is designed to allow a user to circumnavigate a phone tree that is used by a business or non-profit entity.

### BACKGROUND OF THE INVENTION

Commercial entities need to have contact with their clients in order to make them profitable and to maintain a competitive edge. Commercial entities can increase profits either by an increase in revenue or by a decrease in expenditures. One such way that commercial entities decrease expenditures and consequentially maximize their profits is by reducing labor and operational costs. A means of reducing labor costs by commercial entities involves the employment of as much automation as possible.

One example of this automation is by using phone trees when their customers or consumers contact them. Commercial entities usually provide a toll-free number for customers to reach them. This toll-free number does not charge the customer for the phone call, rather the call is charged to the commercial entity. The toll-free numbers have a charge associated with each minute the customer remains on the call and these charges are part of the operational cost for the commercial entities. Entities can reduce their operational costs and increase profits by reducing the time the user remains on the call. For example, when a customer or consumer contacts the commercial entity, a recorded voice may be heard on the phone that indicates that the consumer is to push the phone button 1 or say 1 to reach a given party or department, with subsequent numbers (i.e., 2, 3, 4, etc.) being pushed or said to reach other parties or departments associated with the entity. The user (e.g., the customer or consumer) may have to go through a plurality of menus prior to being able to speak to a person or to reach the database that has the requisite information that the user is seeking. While the company may benefit from not having to employ people to get the user through preliminary information prior to getting to speak to a person or reaching the desired database containing the requisite information, the user may find the fact that the user has to go through these phone trees to be truly annoying and in some instances confusing. Because the user may have to answer questions that the user finds to be unnecessary, the user may forget the menu item in a complex phone tree, or make a mistake in entering the requested information, the user may end up wasting time on the phone that could be used for other things. This wastage of user time can be detrimental to a commercial entity since it has the potential to increase dissatisfaction with the service being provided by the commercial entity, the amount of time the customer spent on the call increases the amount of operational cost associated with the call, as well as the time it may take for the company staff to calm the irate customer or help them retrieve needed information or reach the intended department.

Entities may employ representatives that are very specialized in one area or another. For example, there may be accounting representatives, sales representatives, and technical representatives. If an entity does not employ a phone tree, a representative answering the initial call from the user may have to perform triage to direct the user to the representative that specializes in the area where the user seeks information. Without this initial triage employee or without a phone tree that seeks and gets the information automatically (by having the user input said initial information that directs the user to the correct representative), a representative that is trained in sales may answer the phone call for a user that requires technical assistance. The sales representative then has to transfer the user to another representative that specializes in technical assistance. Thus, it is generally in the interest of an entity to employ a phone tree that performs this initial triage in order to reduce labor costs, increase employee productivity, build process efficiency, and thereby maximize profits.

Entities will often set up their phone trees so that they are able to get as much information out of the user prior to allowing the user to speak to a representative of their company. This further reduces labor costs for the company as the representative will not have to get all of the requisite information from the user. Rather, the user has entered in much of the requisite information prior to speaking to the representative and the representative can spend time on the phone with the user by addressing the crux of the user's issue. For example, the user may be required to enter the user's account information prior to speaking to a representative. When the representative gets on the phone with the user, the representative may already have the account information in front of the representative. This method of information gathering helps with the reduction in labor costs but increases the length of time the user is using the toll-free number. The more time the user spends entering the requested information by the automated phone tree, the more the call costs to the company, possibly reversing the cost benefits gained by reduced labor costs.

Sometimes a user may be able to shorten the amount of time that the user spends on the phone if the user is familiar with the phone tree that the entity employs. In these instances, the user may be able to push buttons prior to hearing the option of a phone tree selection that the user would like to make. This may allow the user to some extent shorten the time that the user spends on the phone before reaching the department or party that the user desires to reach. There is a likelihood that the user may make a mistake in remembering the selections, thus wasting more of their time in the tree navigation. As the need arises, commercial entities may change the phone tree options to meet the demands of the business. In those instances, the user is again forced to begin at the top of the tee and carefully make the selections by following the automated tree system instructions.

Entities have employed automation (e.g., in the form of phone trees) to maximize their profits by minimizing their labor costs. However, phone trees often require the user to enter information that the user deems to be not pertinent (or useless) to having the users' concerns addressed by the entity. The user in many instances is forced to spend much more time on the phone going through the phone tree relative to the amount of time a user would spend on the phone directly speaking to a person. Although others have attempted to design artificial intelligence software programs that might reduce the time a user spends frying to contact a department or party, that software still tends to be significantly slower than the case where a person can be contacted. Accordingly, as a result, the user is still forced to spend more time on the phone than the user ordinarily would. Current phone trees cost customers their most prized possessions, time and peace of mind while business entities face increased operational costs, customer dissatisfaction, employee wastage of time and effort.

It is with these drawbacks in mind that the present invention was developed.

### SUMMARY OF THE INVENTION

The present invention relates to a system that comprises a software program that is associated with a phone or a computer that allows a user to easily and quickly circumnavigate a phone tree associated with an entity thereby reducing or eliminating the annoyance factor of the user and increasing profits for the entity. The user is able to quickly enter the required information in advance, visually navigate the phone tree system automatically, and reach the intended information or department while not having to actively interact with the phone tree after dialing the phone. Thus, while the software program works through the phone tree program automatically to contact the department or entity that the user desires to contact, the user can set the phone aside while occupying the user with other tasks. This method of calling reduces the amount of time the user is on the call, accurately retrieves the intended information or reaches the intended department consistently. Commercial entities can increase profits, reduce operational and labor costs, increase employee productivity while increasing customer satisfaction by implementing this invention in their company.

In one embodiment, the user is provided a software program that shows a phone tree for a commercial or other entity and allows a user to indicate which party in the phone tree the user wants to reach. In an embodiment, after selecting the party that the user wants to reach, the software program associated with the phone tree allows the user to reach the party without having to continually push numbers (on the phone) or without giving speaking commands (e.g., via Interactive Voice Response) to reach said party. In an embodiment, once the party is reached, the software program optionally has the ability to notify the user that the party has been reached and the user can get on the phone to speak to or address the desired department, database, and/or party.

### BRIEF DESCRIPTION OF THE FIGURES

FIG. 1 shows a sample screen shot of the computer executable computer program such as a mobile application allowing the user to select the entity that the user desires to reach.

FIG. 2 shows a sample screen shot of the computer executable program or a mobile application illustrating an exemplary phone tree that may be navigated by a user.

FIG. 3 shows a sample home screen after the application is opened allowing the user to select a company that can be called.

FIG. 4 shows a sample screen with a list of companies from a region where the user resides (based on profile information) that can be adapted to suit a user's whims or profile.

FIG. 5 shows a sample screen of how the user can make a company a “favorite” thereby allowing it to be preferentially presented to a user.

FIG. 6 shows a sample screen with the user's preferred companies.

FIG. 7 shows a sample screen of how the user can remove a company from the “favorite” list.

FIG. 8 shows a sample screen allowing the user to change locales and with information about the computer executable program and the programmer.

FIG. 9 shows a sample screen with a limited number of choices that a user can reach at a company after that company has been selected that allows a user to simply depress the icon associated with the entity or information that the user desires to reach/access.

FIG. 10 shows information associated with a company that the user desires to reach that can be accessed by depressing the company icon as shown in FIG. 9.

FIG. 11 shows a screen shot of the computer executable program showing a telephone number of an entity to be reached and programming showing how the telephone tree can be negotiated.

### DETAILED DESCRIPTION

The present invention relates to a system that comprises a software program that is associated with a phone or a computer that allows a user to easily and quickly circumnavigate a phone tree associated with an entity thereby reducing or eliminating the annoyance factor of the user and increasing profits for the commercial entity. The user is able to navigate the phone tree system automatically while not having to remain active on the phone. Thus, while the software program works through the phone tree program to contact the department or entity that the user desires to contact, the user can be occupied with other tasks.

In one embodiment, the user is provided a software program that shows a phone tree for a commercial or other entity and allows a user to indicate which party in the phone tree the user wants to reach. In an embodiment, after selecting the party that the user wants to reach, the software program associated with the phone tree allows the user to reach the party without having to continually push numbers (on the phone) or without giving speaking commands (e.g., via Interactive Voice Response) to reach said party. In an embodiment, once the party is reached, the software program optionally has the ability to notify the user that the party has been reached and the user can get on the phone to speak to or address the desired department, database, and/or party.

For the sake of the present invention, by phone tree, it is meant an automated telephone information system that “speaks” to the caller with a combination of fixed-voice menus in real time, wherein the automated telephone information system has the capability to allow the user to respond by pressing phone keys or speaking words or short phrases allowing the user to navigate the “branches” on the phone tree. Alternatively and/or additionally, these key presses or spoken words can register information or route calls based on programmed responses associated with the phone tree. In an embodiment, the phone tree must have the user input at least two responses.

In an embodiment, the automated system of the present invention works by software that is designed to navigate the phone tree branches automatically. In one embodiment, the phone tree is provided to the software engineer who writes a program that allows the user to choose the destination in the phone tree where the user desires to be. For example, if the user wants to speak to a person in accounting in United States from multiple locations the entity has offices, the software program (for example, an application on a phone) is designed so that the phone tree is navigated automatically until a person in accounting in the United States is reached. At this point in time, the user may be notified by his phone (for example, by using various notification methods already available on the phone) that a person in accounting is reached and the user can now speak to the person in accounting. For example, a series of menus may have to be traversed to get to the person in accounting in United States if the user were to not use the software she might hear on the phone when a global company is called, “press 1 for business in Asia, press 2 for business in Europe, press 3 for business in the United States etc.” until all of the locations in the phone tree are presented to the user. The user would press 3 to reach business in the United States. Subsequently, the user might hear “please press 1 for research, press 2 for purchases, press 3 for financial services, press 4 for sales”. Upon pressing “3” the user might hear the next menu that states “press 1 for billing or press 2 for accounting services.” Upon pressing 2, the user might subsequently hear, “press 1 for account information, press 2 to speak to a person.” Upon pressing 2, the user may then be directed by the phone tree to the person in accounting in the United States. The user may be placed on hold (with or without music playing) until a person in accounting in the United States answers the phone. Thus, in the above sequence, the user has to sequentially push (or state) the numbers; “3, 3, 2, and 2” to reach the person in accounting in the United States.

The present invention in one embodiment is designed to allow this to happen automatically.

In an embodiment, the executable computer program such as a mobile application may ask a user when first accessing the program in what country the user resides. Accordingly, in one variation, the executable computer program may be tailored to the country where the user resides. For example, if the user indicates that the user is from the United States when profile information is sought, the executable computer program may present the user with companies that are located in the United States. Other information may be asked when the user first accesses the executable computer program that tailors the program to identifying indicia that the user enters. For example, the user may be preferably presented with a list of companies that the user is more likely to call. As an example, if the user banks at Wachovia, Wachovia may be presented as a preferred bank relative to other banks such as Citibank or BB&T. The executable program, in an embodiment, will be flexible so that if a merger occurs or if the profile of the user changes, new preferences may be preferably presented to the user. For example, Wachovia merged with Wells Fargo. The executable computer program would be updated on the user's phone application to reflect this change with Wells Fargo now being a new preference. These changes may be affected either by having the user proactively seek and download the newest version of the executable computer program or by having the newest version of the program uploaded to the user's phone. The uploading may be done in a manner similar to software upgrades on smart phones. The user may be asked “A new version (e.g., Version 9) of the application exists, would you like to download it now?”

In an embodiment, the executable computer program may have phone tree data that is entered either by a programmer or by an entity that has a phone tree associated with it. In one embodiment, it is contemplated and therefore within the scope of the invention that a web based module may be associated with the executable computer program that allows the entry of data by an entity that has a phone tree associated with it. For example, this web based module may allow an entity to enter information pertaining to the phone tree into the module. The module and the identifying indicia (the phone tree information) therein would then be incorporated by a programmer into the executable computer program. In an embodiment, the module itself does not contain the computer executable program, but only sufficient programming that allows an entity to enter phone tree information into the module in a user friendly manner. The module than may be made a part of the larger executable computer program that allows use by a user desiring to use the program. Having the information compartmentalized by incorporating these modules (from a web based system) allows new entities to have their phone tree information entered seamlessly into the overall executable computer program.

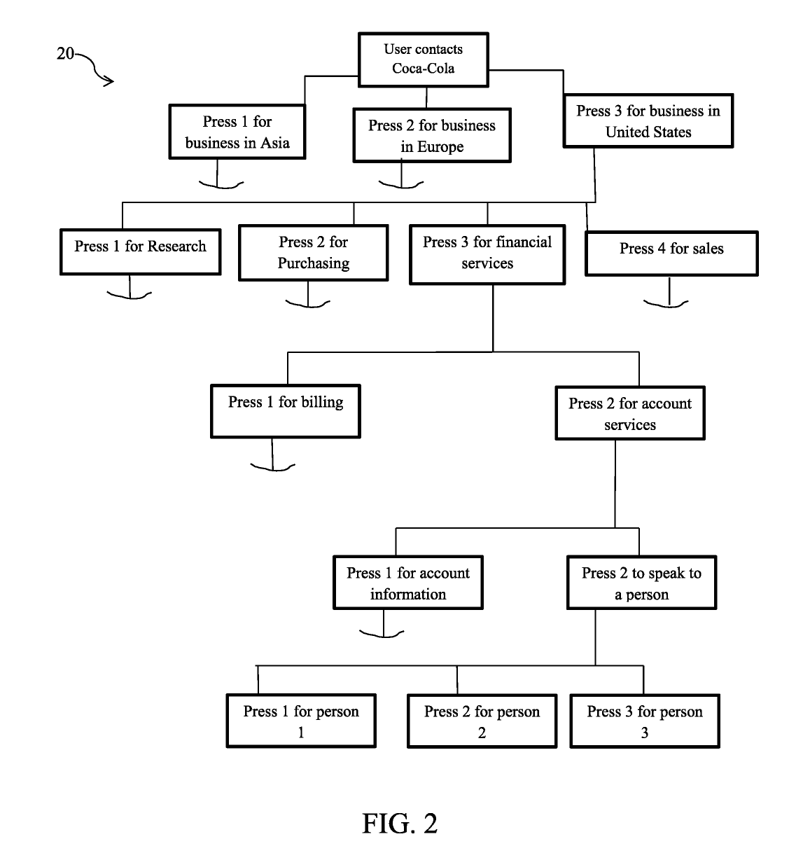

In one embodiment, another aspect of the executable computer program is that the program allows the user to use the program by either menu driven commands or by text driven commands, or by a combination of the two. The text driven commands may be entered to allow a user to pick which department or person the user desires to reach in the entity. If text driven commands are used, the user may be able to enter information more rapidly into the query, thereby also reaching the party of interest more rapidly. Generally, text driven commands are preferred in an environment where the user has more knowledge of the party or department that the user is trying to reach (e.g., the user knows the name of a party the user is trying to reach). With menu driven commands, the user is often given choices as to which path the user wants to follow (for an example of a path that may be chosen, see FIG. 2). Menu driven commands may take longer for a user to negotiate the phone tree but may be useful in the situation where the user may not have institutional knowledge of the company, or the party or department that the user is trying to reach.

When text driven and menu driven commands are used in concert, the user may be able to select some of the phone tree pathway by menu driven commands but other parts of the pathway by text driven commands. In an embodiment, the user may be asked questions by the executable computer program that determines if the program will be text driven or menu driven. For example, the user may be asked the question “Do you know the party that you are trying to reach?” The user may be presented with the choices “yes” or “no”. If the user selects “yes”, then the next screen presented to the user may be a text driven command screen wherein the user can start typing in the name or department that the user desires to reach. If “no” is selected, then the user may be presented with a menu driven command screen that allows the user to select amongst various possibilities the path that the user desires to take (see, for example, FIG. 2). In an embodiment, a search box can in incorporated on the menu driven screen, which would present the queried information as the user types.

In one embodiment, a master menu might be presented that allows a user to depress a key or depress the touch screen (or potentially have voice recognition software that allows the user to say something) that will allow the user to pick the company that the user desires to reach. For example, the user may have a list of companies like Pepsi, Coca-Cola, GEICO, Wells Fargo, etc., that allows a user to indicate which company the user wants to call. When the user selects the company, a series of additional menus may come up that allows the user to reach certain divisions, departments, parties, etc., within that company. Alternatively, the user may be presented with a text driven command menu.

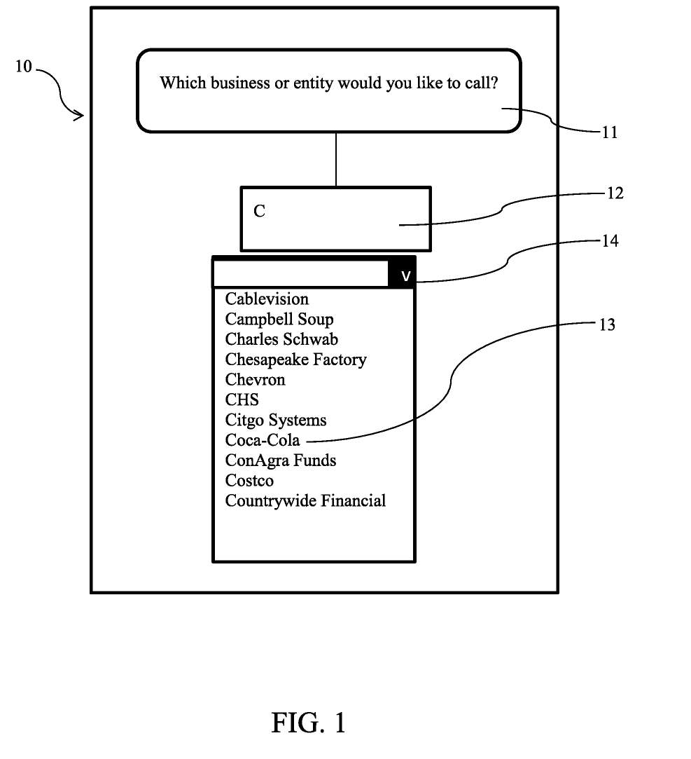

In an embodiment and as shown in FIG. 1, the computer program may have a display 10 that includes a question box 11 that may pose questions to a user. The display 10 may also include a search box 12 that allows a user to type in a word or start typing in a word that allows the user to reach a particular company. For example, the user may start typing “C . . . ” as shown in FIG. 1 and the program would display various companies in an answer box 13 that start with the letter “C”. See FIG. 1. If the user types “C—O . . . ”, the companies Coca-Cola, ConAgra Foods, Costco, and Country Wide Financial might be companies that show up in the answer box 13 (not shown in FIG. 1). Associated with the answer box 13, there may also be a way for the user to use menu driven commands by way of selecting the choice of the company that the user desires to reach by means of a selection arrow 14. The user may desire to reach someone at Coca-Cola so that might be selected by the user. The user than may be presented with a next screen (for example as shown in FIG. 2) that allows choices to be made within the phone tree at Coca-Cola.

In an embodiment of the invention, the system/computer program of the present invention shows at least a part of a map of the phone tree on a touch computer screen that allows the user to see the various departments and/or parties that are available at a commercial or non-profit entity. Alternatively, the phone tree might show at least a part of a map of the phone tree that shows locations where the company (commercial entity or non-profit) may have places of business.

FIG. 2 shows at least a partial map 20 of a phone tree. This partial map 20 is what the user may encounter after selecting Coca-Cola as shown in FIG. 1. The user would typically call and have a first menu that allows the user to select the location of the business. As shown in FIG. 2, the user would press (or say) 1 for the business in Asia, press (or say) 2 for the business in Europe and press (or say) 3 for the business in North America or the United States. If the user selects 3 (business in the United States), the second menu associated with picking that business (in the United States) is then given. The second menu presents the user with the choices of 1 for Research, 2 for Purchases, 3 for Financial Services, or 4 for Sales. The user might select 3 for Financial Services and get the third menu. The third menu might present the user with a choice of 1 for Billing and 2 for Account Services. A selection of 2 for Account Services would produce a fourth menu wherein the user can select 1 for Account Information or 2 to speak to a person. The user than may be presented with a fifth menu that gives the user a list of people from whom the user can select with whom he wants to speak.

It should be noted that FIG. 2 does not display the full phone tree as each of the selections that were not made may have different menus associated with them (and they are not shown in FIG. 2). However, FIG. 2 is illustrative of what may be presented to a user in a computer executable program (for example, in a smart phone application). The user might be presented with a screen on the application that only has the first menu (i.e., 1 for the business in Asia, 2 for the business in Europe and 3 for the business in the United States). The user would depress the screen where the United States is located (on the screen). Upon depressing the screen at or near the United States, the second menu would appear on the smart phone screen. That is the user would be presented with the second menu as shown in FIG. 2 (i.e., 1 for Research, 2 for Purchases, 3 for Financial Services, or 4 for Sales). The user would again select his choice and depress the screen at or near the place where Financial Services appears at which point the third menu as it corresponds to the submenu (the third menu) that is below Financial Services would appear. The process would continue until the party that the user desires to reach is selected. The user then might be presented with another screen that asks the user if the user desires that a call be made to the selected entity. The user may be presented with a couple of choices. These choices, for example, might be “yes”, “no”, “go back to previous menu”, or “start again”. If the user depresses “yes”, the application (computer executable program) will automatically dial the number, and will wait until someone answers the call before the user is notified. The computer executable program may be programmed so that the user is not notified until someone answers on the phone meaning that the user does not have to wait while silence or music (often annoying) waits for the desired party to be free.

In one embodiment, the user may push or depress a key or the touch screen (or potentially have voice recognition software that allows the user to say something) that allows the user to arrive at the next menu (going along one branch of the phone tree). At the next menu, the user may push or depress a key or the touch screen (or potentially have voice recognition software that allows the user to say something) that brings up the subsequent menu. The user can continue to go through menus until the user reaches the desired department or party. After depressing the keys, the software program that may be associated with a cell phone will dial the number of the company and automatically go through the various menus until the desired party is reached. The user does not have to listen to the menus and the user can leave his/her phone aside and when the party or department is reached, the user can talk to the person on the phone or listen to the information being presented. The phone may potentially notify the user that the desired party or department has been reached. The notification may be in the form of an audio signal or a visual signal or both. Because the computer program associated with the phone is able to do this automatically, the user can be occupying himself/herself with other tasks.

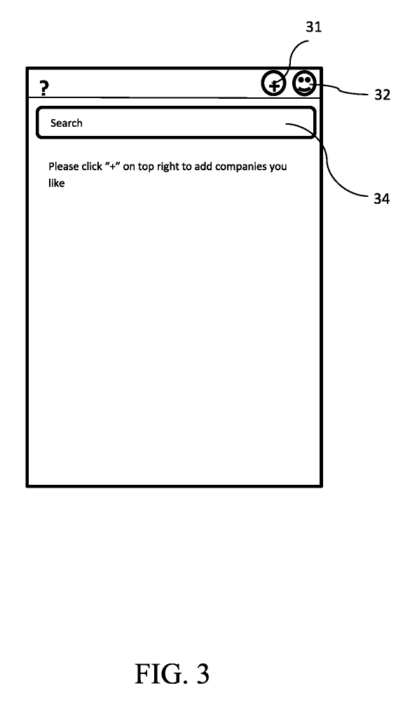

FIG. 3 shows a typical home screen of the program, which may be on a computer or part of an application for a smart phone. In FIG. 3, the user is presented with a search box 34 and various symbols 31 and 32 that the user can touch to get different screens to appear. For example, by depressing the “+” symbol 31, the user will be presented with a list of companies that the user can select to add to the user's favorite companies. By starting to type a company name in the search box, the user will be presented with companies that start with the letter(s) that the user types.

In an embodiment, the computer program may have a search box that allows a user to type in a word that allows the user to reach a particular company. For example, the user may start typing “C . . . ” and the program would display various companies that start with the letter “C”. If the user type “C—O . . . ”, the company Coca-Cola might be one of the companies that is displayed as a company that the user might try to reach. See FIGS. 1 and 3.

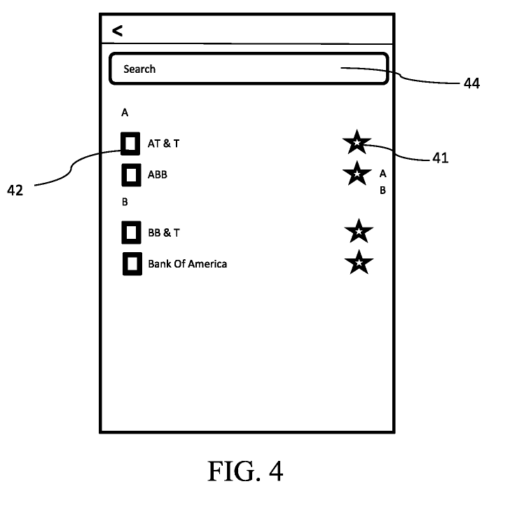

By depressing the “+” symbol 31, the user may be presented with a screen that is exemplified in FIG. 4. As shown in FIG. 4, the user may be presented with companies that the user can add to his favorites by depressing the star 41 adjacent to the company name. For example, if the user has AT&T as his carrier for service on his cell phone, the user may depress the star 41 that is associated with AT&T to add AT&T to his list of favorite companies that will be shown when the first accesses the program, which will be shown on his home screen. In an embodiment, the star 41 that is associated with AT&T may serve as a toggle that allows AT&T to also be removed as a favorite by again depressing the star associated with AT&T. There may also be a search box 44 associated with this screen that will allow the user to use text driven commands to get to companies that start with letters later in the alphabet. For example, by typing the letter “C”, the user will be presented with companies that start with the letter “C” (for example, as shown in FIG. 1). In one embodiment, the user may only be presented with companies from countries that are associated with the country that the user selects when entering information in the user's profile.

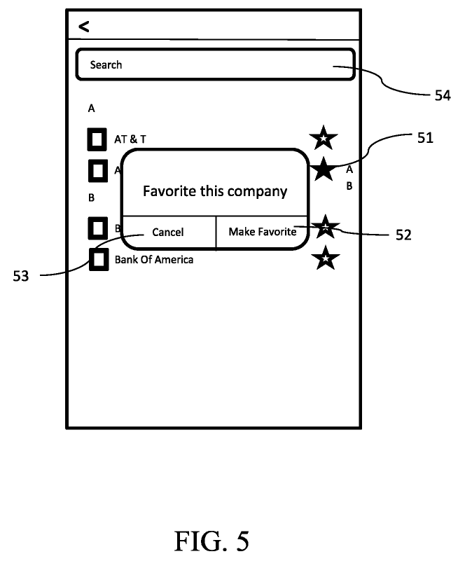

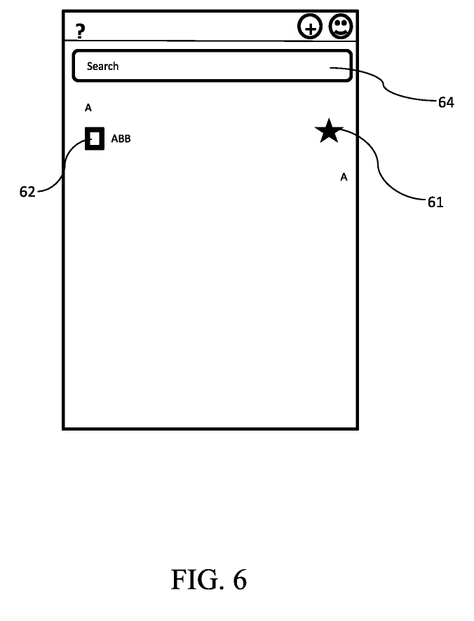

In an alternate embodiment, the user may be presented with another submenu as shown for example in FIG. 5, when the user selects the star associated with the company the user desires to add to his list of favorites. For example, if the user selects company ABB (as shown in FIG. 4), the star associated with company ABB may change from a star 41 outline (as shown in FIG. 4) to a filled in star 51 (as shown in FIG. 5) and a submenu may be presented that gives the user a choice to select company ABB as a favorite 52 or to cancel 53 the selection. By making company ABB a favorite, the company ABB will be made a part of the user's home screen when the application is first accessed. By selecting “cancel” 53, the filled in star associated with ABB will change back to the star outline and the company ABB will be deselected as a favorite company. If company ABB is selected as a favorite, it will show up on the user's home screen as shown in FIG. 6 (note that the star 61 is also filled in).

As shown in FIG. 6, by depressing the company name or a box 62 adjacent the company name (in this case, ABB), the phone tree can be accessed for that particular company.

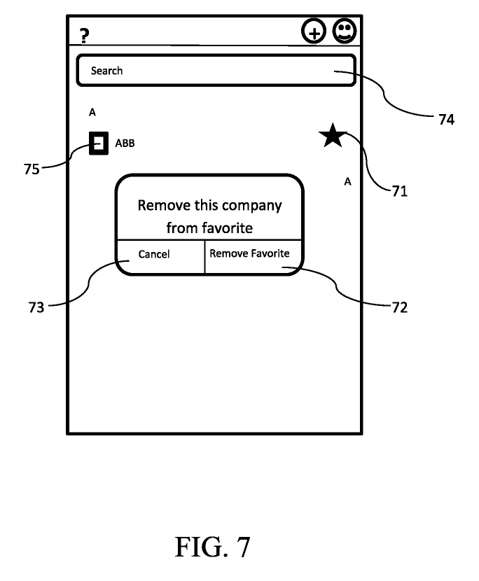

In an embodiment, if one depresses the star 71 associated with the company ABB as shown in FIG. 7, the user may be presented with the option of deselecting company ABB as a favorite company. The user may be given a choice to remove favorite 72 thereby deselecting the company from the favorites of the user or alternatively to cancel 73 the removal, thereby not removing the company from the user's favorite companies. By depressing the screen on the company name or on a box 75 close to the company (ABB, in this instance), the user may be presented with screens that access or allow the phone tree to be accessed.

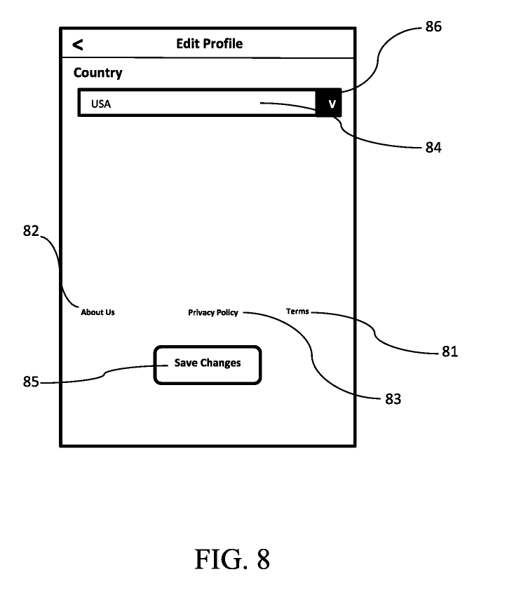

By depressing the smiley face icon 32 in FIG. 3, the user is able to edit the profile of the user. In an embodiment, one of the features that comes up when the user edits his profile is the country 84 in which the user desires to use a phone tree as seen in FIG. 8. There may also be a pull down menu 86 that allows a user to see a plurality of countries that can be accessed and made the country of the user's preference. Although, not shown, it should be understood that other features can be associated with the user's profile, such as the user's name or other identifying indicia. As shown in FIG. 8, when the edit profile screen is accessed, there may be other information that the user may be able to access such as information about the programmer (or others) such as an about us 82 link, or contractual language such as the privacy policy 83 of the program as well as the terms 81 for using the program. The screen may also contain a save changes 85 link that allows the user to save any changes that are made on the user's profile, such as the preferred country. By initially selecting the country in which the user desires to use a phone tree, the user will be preferentially (and optionally only) presented with companies in the country that the user selects (for example, as shown in FIG. 6).

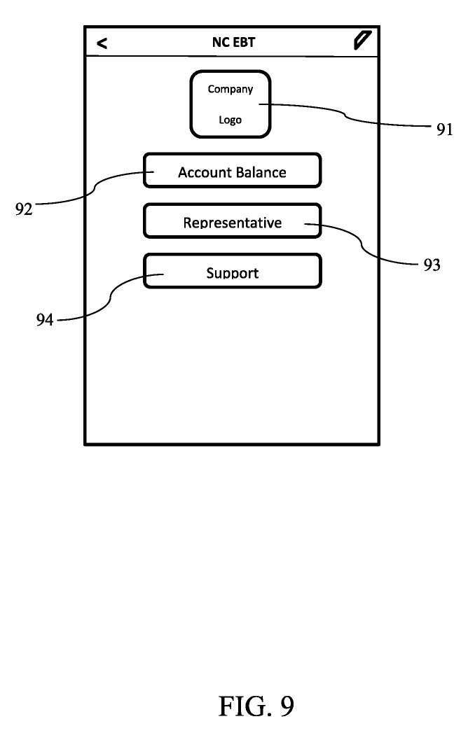

Once the user desires to use the phone tree associated with a company, the user can select the company that the user desires to use the phone tree by depressing the company name or a box adjacent to the company name on the user's favorite company list (for example as shown in FIG. 6). The user depresses the screen on “ABB” or the box and additional questions are presented to the user. Alternatively, in one embodiment, the user may be presented with limited choices in association with a particular company (see FIG. 9). For example, when the user depresses company NC EBT on the screen or the box associated with company NC EBT, the user may be presented with a screen that gives the user limited numbers of choices associated with company NC EBT. As, shown in FIG. 9, the user may be able to access account information such as account balance 92, a representative 93, or support 94. The user would simply have to depress the party or entity that the user desires to reach and then let the computer program undergo its execution navigating through the phone tree to reach the party or entity or access the information that the user desires to access/contact. The executable computer program is adaptable so that additional choices can be added by the user and/or alternatively, by a programmer.

The computer executable program can also be adapted to be customized for an individual company or entity and navigation through only that company's or entity's phone tree. If a company or entity wants to deploy this program to their customers to contact them, then this application can be provided to them with a phone tree specific to their company. Alternatively, a series of companies or entities could give it to their customers with access only to their companies or entities. In these cases, the user would not have the option in the computer executable program of selecting any other companies to navigate their phone trees and the computer executable program (e.g., application) would simply present the user with the choice of menus for that one company or entity, or in the case of several companies or entities, only those several companies or entities.

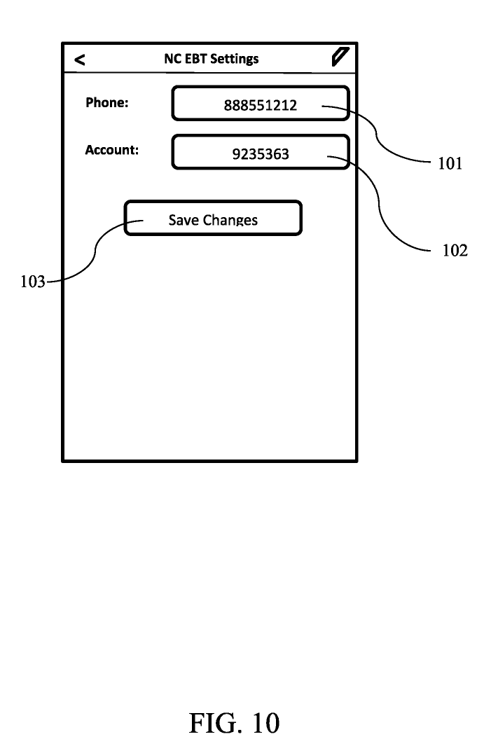

By depressing the icon for that contains the company logo 91, the user may be presented with another screen as shown in FIG. 10. In FIG. 10, the user may be presented with requisite information such as the phone number 101 of the company, the user's account number 102 with that company. By depressing the space where the phone number 101 exists, the user is able to enter for the first time or edit the information contained in this box. Similarly, the user may be able to access the account number 102 by the same process and enter a new account number or edit an account number. Once the user has entered the phone number and/or account number, the information is saved by the executable computer program and is used to navigate the phone tree at the company NC EBT by using the phone number and the account information entered.

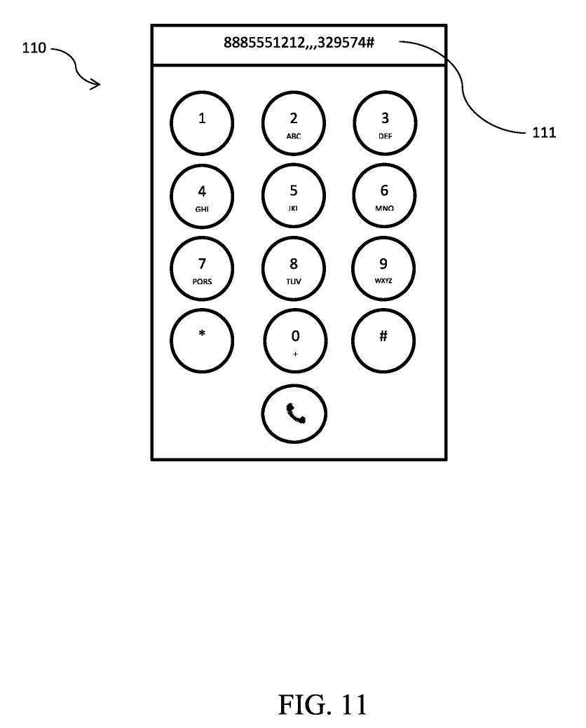

FIG. 11 shows a screen shot 110 of a display 111 comprising a telephone number of an entity to be reached and programming associated with negotiating the phone tree associated with that entity. It should be noted that the display 111 indicates the order in which a phone tree is to be navigated. First the telephone number (888-555-1212) is called, and then the executable computer program is instructed to wait three pauses as indicated by the commas. The pauses may be on the order of 1-5 seconds in length or any length of time dependent on the required time necessary to navigate the phone tree. Alternatively, the pause may be two seconds in length. It should be understood that a shorter pause may be preferred as the programmer can easily input a plurality of pauses to get the requisite amount of time needed in total for a pause. The pauses may be interspersed where needed according to the phone tree that is accessed. In the screen shot 110 shown, the three pauses occur immediately after the phone tree is accessed. The pauses may be input as the phone tree may not immediately allow the entry of the requisite information that is necessary to be entered to negotiate the phone tree. In the instant screen shot 110, the three pauses may be necessary prior to entering the account information with the user's account number (e.g., 329574) with the pound (#) key being entered so that the phone tree knows that the user's full account number has been entered.

It should be noted that although this screen shot 110 shows a display 111 with the telephone number of the phone tree to be accessed and the user's account information, a slightly different screen shot may show the numbers that are “pushed” (i.e., executed by the computer executable program) to navigate the phone tree. For example, the number “3” might be “pushed” followed by a pause (i.e., a comma) to select the third selection in a first menu of choices and to allow a little time prior to entry of the selection choice in the second menu. Similarly to the input of selection “3” in the first menu, the number “2” might be “pushed” in a second menu to indicate that the second selection in the second menu is chosen. A pause (i.e., a comma) might be required after making the selection in the second menu. The same pattern may follow for subsequent menus with “9”, “5”, “7”, and “4” being chosen until the requisite party or department is reached. It should be noted that the user may be presented with the display as shown, for example, in FIG. 9, and upon pressing the choice of the party/information that the user desires to reach, the computer executable program will carry out the commands as shown in FIG. 11 to reach said party/information.

It should be noted that one advantage of the computer executable program of the present invention is that the requisite information to reach a given party or department at an entity can be stored so that it only needs to be input one time by a user. The information can be stored on the phone application (which Applicants contemplate as having security associated with it so that this information cannot be hacked). For example, all information associated with a credit card (like the card number, expiration date, name, card security code number, etc.) can be stored on the application so that when the user desires for example, to reach account information associated with that credit card, the user does not have to repeatedly enter the information into the computer executable program when it places a call. In one embodiment, the user may be presented with a choice as to whether the requisite information is to be stored.

As another example, the user may desire to reach someone at Coca-Cola. The user would depress Coca-Cola in his home screen. Although not shown in any figures, the user may be presented with a menu that asks “At which location would you like to contact Coca-Cola?”. Coca-Cola has over 900 bottling plants and has offices throughout the world. The user may be presented with a menu that lists “Africa, Asia Pacific, Eurasia, Europe, Latin America, North America” as choices. The user might select “North America” as his choice by depressing the screen or alternatively, by stating “North America”. The user may then be presented with another menu asking “Where in North America would you like to contact Coca-Cola?” The user may select the “Coca-Cola bottling company of Southeastern New England” from a plurality of choices as the location that the user desires to reach. The user may be presented with another menu that states “Which Department at the Coca-Cola bottling company of Southeastern New England would you like to reach?”. The choices may be as shown in a manner similar to that shown in FIG. 2. That is upon contacting Coca-Cola in Southeastern New England the user may be presented with an exemplary menu that shows an Administrative Department, a Sales Department, an Operating Department, and a Service Department. The user might select the “Sales Department” as the user may be interested in speaking to someone who manages Advance Salesmen. Upon selecting Sales Department the user may be presented with a menu that contains the sub-departments in the Sales Department. The menu might give the user a choice between “marketing, sales, salesmen, route merchandisers, and bulk drivers”. Upon choosing “salesmen”, the user may be presented with a menu that has the individual names of people that work in connection with salesmen (and/or are salesmen).

By proceeding through these menus one at a time, the application will store the data so that when the application is executed by the computer, the user will reach the person, department or entity that the user desires to reach. It should be noted that the user does not have to stay on the phone while the application is working (that is, the program is executed). Rather, the user may be notified by a visual means or alternatively and/or additionally by an audible signal that indicates that the desired party is reached (contacted).

In an embodiment, the user may be presented with a search box after the company is selected that allows a user to bypass many of the intermediate steps of menus. For example, after the company is selected, a search box may appear that allows a user to type “representative” (or merely a part of “representative”—e.g., “rep . . . ) and a menu may be presented that shows a plurality of types of representatives that can be reached. For example, a menu may be presented that has a choice between, “account representative”, “billing representative”, “customer service representative”, “sales representative”, etc. The user may select one of these representative (by, for example, a touch screen). For example, the user may desire to reach a customer service representative to ask about a product that a company sells. In one embodiment, the application may show the intermediate menu steps that were skipped to reach the desired representative. That way, the user may see that he is or is not going to contact the representative that he desires to reach.

In an alternate embodiment when the user is trying to reach a representative at Coca-Cola, after the user types “rep . . . ”, the user may be presented with a list of employees at Coca-Cola that work as representatives at the company. There may be other identifying indicia associated with the employee that is presented with the name of the employee that allows a user to contact the representative that meets their needs. For example, if “rep” is typed by the user, one choice that may be presented to the user is “Mr. Smith, sales representative”. The user can depress the screen where “Mr. Smith, sales representative” appears and the program may then be ready to navigate the phone tree to reach Mr. Smith, who works as a sales representative. The user may be presented with another screen that asks the user if he is certain he wants to reach Mr. Smith, the sales representative. By selecting “yes”, the executable computer program will be executed and the phone tree will be navigated by the computer program and the user will be notified as described herein once Mr. Smith is reached. If the user selects “no”, the user may be presented with another screen that says “would you like to reach someone at Coca-Cola?”. If the user selects “yes”, the user will start the process anew. If the user selects “no”, the user may be presented with another screen that says “would you like to use the phone tree application?” By selecting “yes” to this question, the user may go back to his home screen. By selecting “no” the program may shut.

As can be ascertained by the above example, the phone tree application (executable computer program), in one embodiment, is designed to be user friendly so that the phone tree can be executed in an intuitive manner. The user is presented with options (often as “yes/no” questions) that allow the user to either proceed in navigating the phone tree in the direction that the user does or by returning the user to a preceding screen, allowing the user to make selections on the higher order menus. The user may also be presented with a search box that allows the user to use text driven commands to more rapidly navigate the phone tree (usually used if the user is somewhat familiar with the phone tree).

The user may also be presented with menu driven commands that allows the user to select choices (usually to be used by the user when the user is not familiar with the phone tree). In another embodiment, the user is presented with a combination of text driven command possibilities and menu driven command possibilities that allow the user to use a combination of the two ways of using the program.

In an embodiment, there are several layers of programming that may be associated with the computer executable program (e.g., an application for a smart phone). There might be a first underlying layer that contains the executable computer program and allows the computer program to be executed so it performs the desired task (e.g., automatically reaches the party or person desired to be reached). There may a second layer that allows the entry of data in a modular form (see the discussion above regarding modules) that allows additional entry of phone tree information from different entities as it becomes available. There may be a third layer that allows the user to enter queried information into the program tailoring the program to the user (note the discussion above regarding the user profile information) and also allowing the user to enter information that makes the computer executable program tailored to that particular user.

In an alternate embodiment, there may be several levels of programming associated with the executable program. A first level of programming is the highest order program (which may be machine language) that is a program that is able to accept data entered by a programmer or a company. This first level is a level of programming that is adaptable that is able to accept the phone tree data. The first level is able to accept more companies/entities as they become available. For example, the first level of programming is able to accept the entry of data from Coca-Cola and then, at a later time may be able to accept the data from a second company, e.g., Wells Fargo. The first level is designed in such a way as to be adaptable to many different means of entry of the data. A second level of programming is the phone tree data itself associated with the company/entity. Because different companies may possess different phone trees (some being shorter and less complicated than others), the first level of programming should be sufficiently robust and adaptable to accept a vast array of different phone trees. The second level of programming can be entered either by a programmer, or by a company, or by an individual user. It is contemplated and therefore within the scope of the invention, that an individual user may be able to “effectively program” by simply downloading/uploading the phone trees. The phone tree data may be stored on a central server that can be occasionally accessed to update the phone trees as the phone trees change or additional companies/entities are added to the database.

The third level of programming is the input of data from the user and is part of the executable program.

In a further embodiment, a computer programmer may write a computer program that allows the phone tree information to be entered manually on a computer. The programmer would call the phone tree at an entity on his phone and listen to the phone tree. The programmer would take notes of the plurality of paths that can be taken on the phone tree to generate a phone tree map for that entity and use that map to enter the requisite information on the program so that when the program is executed any of the plurality of paths can be accessed by a user. In an embodiment, it should be understood that this information may be held on a local or distant server that will be automatically downloaded to a user's phone.

In an alternate embodiment to the above embodiment, a program may be written that allows a computer to access a phone tree at an entity. The program may have voice recognition software associated with it (as well as the ability to type that information) that allows it to take notes of the plurality of paths that can be taken on the phone tree, thus, automatically generating a phone tree map for that entity. In this instance, the requisite information is automatically entered by the program so that when the program is executed any of the plurality of paths can be accessed by a user.

In another embodiment, the phone tree map may be generated by an entity that has a phone tree associated with its call center. The entity may then send the phone tree map to a programmer who enters the information into an executable computer program that may be on a computer, server or a smart phone (or transferred from any one to any other one). In one embodiment, the entity may be provided with a program from a programmer that facilitates entry of the requisite information to generate the phone tree map.

In an embodiment, the data associated with a company/entity that allows the executable program to be executed can be entered either by a programmer or by the company that has a phone tree associated with it. In an embodiment, an underlying program is written that makes it very user friendly for the phone tree data to be entered and become associated with the executable program.

In an embodiment, the computer executable program works by automatically dialing the number of the entity the user is trying to reach and appropriately selecting the correct selections as the phone tree is presented to the computer executable program. In an embodiment, the computer executable program is set up so that selection choices are made as soon as possible. That is, in one embodiment, testing is done to see how soon a selection can be made that will present the computer executable program with the next sub menu. For example, a phone tree at an entity may require that a caller wait until the entire choice is “verbalized” by the phone tree before the caller can make a selection. Another entity may allow a selection to be made prior to the choice being “verbalized”. In one embodiment, the computer executable program is optimized to minimize the time (that is, selections are made immediately after they are available to be made). In this way, not only does the user not have to remain on the phone while the selections are made, but the user will have to wait less time before the desired party or person is reached.

In an embodiment, the computer executable program may give a warning signal to the user indicating that the party, department, or person that the user is trying to reach is about to occur. For example, the computer executable program may indicate to the user that the party, department, or person that the user is trying to reach is 5 seconds away from the signal. In an embodiment, the computer executable program may also have a functionality that allows a user to not be signaled until a person picks up the phone. In this embodiment, this would allow the user to not have to endure wait times on the phone while silence or annoying music plays. When a person from the entity picks up the phone, the user is notified that a person has picked up the phone.

In an embodiment, the computer executable program may also be able to input appropriate data into the phone tree. For example, if a user using the computer executable program were to call a credit card company to ascertain the user's balance, the phone tree might request information about the credit card, for example, the credit card number, the name on the credit card, the date of expiration of the credit card, and the three or four digit code on the back of the card. In an embodiment, the computer executable program will be able to enter or “verbalize” all of this information. Thus, when information is asked that does not require the input of a number (for example, if the phone tree asks for a name), the computer executable program in an embodiment may be able to “verbalize” the requisite information. Because the computer executable program “knows” that certain information needs to be entered, the user may be alerted to this prior to allowing the computer executable to execute the program to navigate the phone tree. The user may be able to record his name audibly on the computer executable program so that when the requisite information (e.g., his name) is called for on the phone tree, the computer executable program will “verbalize” the name, allowing the phone tree to continue to be navigated.

In an embodiment, the computer executable program is designed to prompt the user so that the requisite information necessary to navigate the phone tree is entered into the program prior to the computer executable program being executed to navigate the phone tree. That is, the requisite information to navigate the phone tree is entered so that the program can completely navigate the phone tree without further input from the user during the programs execution. In an alternate embodiment, the program may be designed to allow the user to enter requisite information into the program while the program is being executed (i.e., navigating the phone tree).

In an embodiment, the present invention relates to a system for automatically circumnavigating a phone tree associated with an entity, said system comprising a non-transitory computer readable recording medium encoded with a computer program, which when executed by a computer system causes the computer to execute a series of commands allowing a user to automatically navigate one or more branches in a phone tree to contact a party or department within said entity, wherein said party or department ordinarily cannot be directly contacted without a user having to input indicia associated with the phone tree.

In a variation, the system further notifies the user that the party or department has been reached. In a variation, notification of the user occurs in any form such as by an audible signal or a visual signal. In a variation, the audible signal of sound is a ring or chime.

In an embodiment, the system further comprises a visual map of the phone tree. In a variation, the visual map further comprises at least one menu. The system may also comprise a plurality of menus. In an embodiment, the visual map allows the user to see a location in the plurality of menus. By this, it is meant that the visual map allows a user to see where in the phone tree the user is. For example,

In an embodiment, the system comprising the computer program resides on a cell phone. Alternatively, in a variation, the computer program resides on any computing device such as a desktop or laptop computer.

In an embodiment, the computer program navigates from at least a first menu to a second menu, and the computer program is designed to wait for feedback from the phone tree prior to navigating from the first menu to the second menu. In a variation, the feedback is a prompt to push a phone key or to state a number.

In an embodiment, the present invention relates to a method to automatically navigate a phone tree performed by one or more processing devices having a touch computer screen associated with the one or more processing devices, said method using an executable computer program executed by the one or more processing devices, said computer program when executed designed to display a map of a phone tree to a user, said phone tree having at least a first menu and a second menu on a touch computer screen, allowing the user to input data onto the touch computer screen, wherein said data comprises instructions to the one or more processing devices to navigate from the first menu to the second menu in the phone tree.

In a variation of the method, the phone tree comprises a map of the phone tree that displays the first menu and the second menu simultaneously on the touch computer screen.

In an embodiment, at least one of the first menu and the second menu comprise data or information that allows the user to reach a party or department in a commercial entity.

In an embodiment, the data that is input is a user touching the touch computer screen, thereby providing instructions to the computer program to reach a party.

In a variation, the one or more processing devices is associated with a mobile cell phone. In an embodiment, the mobile cell phone is an iPhone. Alternatively, the mobile cell phone is a cell from Apple, Samsung, Motorola, Nokia, LG, or any other company that makes mobile cell phones.

In an embodiment, the executable computer program notifies the user when the party or department is reached. In a variation, the user is notified by an audio signal, a visual signal, or vibration or any combination of notification methods.

In an embodiment, the present invention is directed to methods of saving money for companies. Companies often have to use toll free numbers that support their phone trees. These toll free numbers are charged a usage rate that is dependent on the time that a caller is on the phone (using the phone tree). Because the computer executable program is designed to not only reduce the number of errors made by a caller but also designed to not have delays that occur when a caller uses the phone tree, it is believed that the instant computer executable program will save significant money for companies. One other means that money can be saved is that it is contemplated that the computer executable program may be able to use a non-toll free number to access certain companies instead of the toll free number associated with that company. Because the phone tree may be accessed by a non-toll free number, this will save companies money because they do not have to make payments to the phone company for the non-toll free number. Moreover, because many users will have unlimited calling plans that allow the user to call any number without additional expense, the user will also not have to pay for accessing a phone tree on a non-toll free number.

In an embodiment, the present invention relates to methods of saving time for a user. It is contemplated that the user may be able to undergo only two or three clicks (i.e., depressing the screen two three times) to reach an entity at a company. The first click will be the user opening the application on his smart phone. The second click would be a click of the company that the user desires to reach. If, for example, the user only accesses account information associated with that company, the second click on the company name may automatically access the user's account information. If the user has more possible choices associated with the company (e.g., representative, account information, etc.), the user may be required to click a third time to access, for example, his account information.

In an embodiment, it is contemplated and therefore within the scope of the invention that any feature that is discussed above can be combined with any other compatible feature even if they are not discussed or disclosed together. It should be recognized that modules of a computer program can be combined with other modules from a computer program to perform any one or more of the tasks described above even if those tasks are not described together. In any event, the invention is defined by the below claims. It should be apparent that minor modifications can be made to the present invention without departing from the spirit and scope of the invention.

1. A system for automatically circumnavigating a phone tree associated with an entity, said system comprising a non-transitory computer readable recording medium encoded with a computer program, which when executed by a computer system causes the computer to execute a series of commands allowing a user to automatically navigate one or more branches in a phone tree to contact a party or department within said entity, wherein said party or department ordinarily cannot be directly contacted without a user having to input indicia associated with the phone tree.

2. The system of claim 1, wherein the system further notifies the user that the party or department has been reached.

3. The system of claim 2, wherein notification of the user occurs by an audible sound, physical vibration, or a visual signal or any combination of notification methods.

4. The system of claim 3, wherein the audible signal is a ring or chime.

5. The system of claim 1, wherein the system further comprises a visual map of the phone tree.

6. The system of claim 5, wherein the visual map further comprises at least one menu.

7. The system of claim 6, wherein the system comprises a plurality of menus.

8. The system of claim 7, wherein the visual map allows the user to see a location in the plurality of menus.

9. The system of claim 1 wherein the computer program resides on a cell phone.

10. The system of claim 1, wherein the computer program resides on a desktop or laptop computer or any computing medium.

11. The system of claim 7, wherein the computer program navigates from at least a first menu to a second menu, and the computer program is designed to wait for feedback from the phone tree prior to navigating from the first menu to the second menu.

12. The system of claim 11, wherein the feedback is a prompt to push a phone key or to state a number.

13. A method to automatically navigate a phone tree performed by one or more processing devices associated with the one or more processing devices, said method using an executable computer program executed by the one or more processing devices, said computer program when executed designed to display a map of a phone tree to a user, said phone tree having at least a first menu and a second menu, allowing the user to input data onto the touch computer screen, wherein the executable computer program comprises instructions to the one or more processing devices to automatically navigate from the first menu to the second menu in the phone tree.

14. The method of claim 13, wherein the phone tree comprises the map of the phone tree displays the first menu and the second menu simultaneously.

15. The method of claim 14, wherein at least one of the first menu and the second menu comprise a-data that allows the user to reach a party or department in a commercial or any type of entity that has a phone tree.

16. (canceled)

17. The method of claim 13, wherein the one or more processing devices is associated with a mobile cell phone.

18. The method of claim 17, wherein the mobile cell phone is an iPhone.

19. The method of claim 15, wherein the executable computer program notifies the user when the party or department is reached.

20. The method of claim 19, wherein the user is notified by an audio or visual signal, or both.

21. (canceled)
